(19) United States
(12) Patent Application Publication
(10) Pub. No.: US 2025/0219414 A1
(43) Pub. Date: Jul. 3, 2025

(54) CONTROL DEVICE

(71) Applicant: HONDA MOTOR CO., LTD., Tokyo (JP)

(72) Inventor: Takayuki SAKURAI, Tokyo (JP)

(73) Assignee: HONDA MOTOR CO., LTD., Tokyo (JP)

(21) Appl. No.: 18/991,704

(22) Filed: Dec. 23, 2024

(30) Foreign Application Priority Data
Dec. 27, 2023 (JP) 2023-220633

(51) Int. Cl. H02J 3/00

(52) U.S. Cl. CPC H02J 3/007; H02J 3/004

(57) ABSTRACT

A control device for controlling charging and discharging of power storage devices respectively owned by consumers who have declared participation in a DR with respect to a power grid, includes: an acquisition unit configured to acquire a usage history; a base line prediction unit configured to predict, for each consumer, a base line which is demand power assumed in a case where there is no request for the DR; a base line correction unit configured to correct, based on information related to a deviation between a usage schedule and an actual usage status of the power storage device included in the usage history, the base line in the DR to be executed this time; and a selection unit configured to select, based on the corrected base line, the power storage device for charging and discharging power with respect to the power grid among the plurality of power storage devices.

This application is based upon and claims the benefit of priority from prior Japanese patent application No. 2023-220633, filed on Dec. 27, 2023, the entire contents of which are incorporated herein by reference.

### TECHNICAL FIELD

The present disclosure relates to a control device that controls charging and discharging of a power grid.

### BACKGROUND ART

In recent years, researches and developments have been conducted on a secondary battery which contributes to improvement in energy efficiency in order to allow more people to have access to affordable, reliable, sustainable and advanced energy.

In recent power systems, it is expected to utilize distributed power sources such as power generation facilities and power storage batteries without depending on large-scale centralized power supplies such as power plants. Further, by controlling a power demand of a consumer, it is expected to reduce an amount of demand for power according to an amount of power supply.

In relation to the control on the power demand of the consumer, there is a business operator called an aggregator which mediates between a provider on a power supply side such as a system operator and the consumer. When the aggregator makes a contract with a plurality of consumers and is requested by the provider on the supply side to control the power demand (hereinafter, may be referred to as an aggregation service), the aggregator controls the power demand for a power storage battery of each of the consumers to achieve the request for the aggregation service. When the request for the aggregation service is achieved, the provider on the supply side pays a reward to the aggregator, and the aggregator pays a reward to the consumers.

JP2019-17135A discloses an aggregation device that improves success probability of the aggregation service.

### SUMMARY

In a service in the related art including that in JP2019-17135A, there is a room for consideration to improve calculation accuracy of a base line which is future demand power so as to sufficiently ensure a power resource that can be supplied in an execution period of a demand response (DR) for adjusting a power supply and demand balance in a power grid.

Aspects of the present disclosure relates to providing a control device capable of predicting a base line with high accuracy and preventing a failure in ensuring a power resource that can be supplied during execution of a DR.

According to an aspect of the present disclosure, there is provided a control device for controlling, based on a request for a demand response (DR) for adjusting a power supply and demand balance in a power grid, charging and discharging of a plurality of power storage devices, that are respectively owned by a plurality of consumers who have declared participation in the DR, with respect to the power grid, the control device including:
an acquisition unit configured to acquire a usage history including a usage schedule of the power storage device received from each of the consumers and an actual usage status of the power storage device of each of the consumers;
a base line prediction unit configured to predict, for each of the consumers, a base line which is demand power assumed in a case where there is no request for the DR;
a base line correction unit configured to correct, based on information related to a deviation between the usage schedule and the actual usage status which are contained in the usage history, the base line in the DR to be executed this time; and
a selection unit configured to select, based on the corrected base line, the power storage device for charging and discharging power with respect to the power grid among the plurality of power storage devices.

According to an aspect of the present disclosure, since the base line in the DR to be executed this time is corrected based on the information related to the deviation between the usage schedule and the actual usage status of the power storage device, the base line may be predicted with high accuracy. Accordingly, the failure in ensuring the power resource that can be supplied during execution of the DR may be prevented.

### BRIEF DESCRIPTION OF DRAWINGS

Exemplary embodiment(s) of the present invention will be described in detail based on the following figures, wherein:

FIG. 1 is a diagram conceptually showing a use form of a system 5 according to an embodiment of the present disclosure;

FIG. 2 is a block diagram of a control device 100 and a diagram showing a relationship between the control device 100 and other devices;

FIG. 3 shows graphs in relation to a usage history during execution of a past DR, including graphs (left side) of an SOC of a battery 12 used respectively by consumers 40A to 40D and graphs (right side) of demand power of the consumers 40A to 40D; and

FIG. 4 shows graphs in relation to a usage schedule of a DR to be executed this time, including graphs (left side) of the SOC of the battery 12 used respectively by the consumers 40A to 40D and graphs (right side) of the demand power of the consumers 40A to 40D.

### DESCRIPTION OF EMBODIMENTS

Hereinafter, a control device according to an embodiment of the present disclosure will be described with reference to the accompanying drawings.

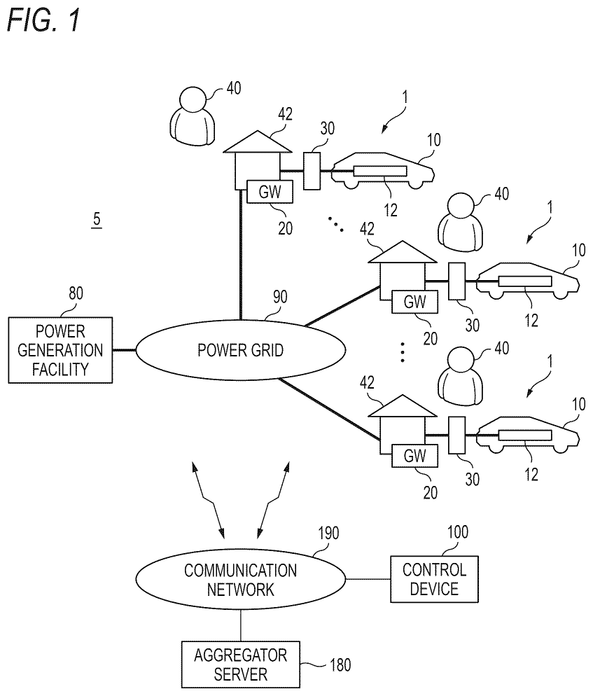

FIG. 1 conceptually shows a use form of a system 5 according to the embodiment. The system 5 includes power storage systems 1 respectively owned or used by a plurality of consumers 40, a power generation device 80, a control device 100, and an aggregator server 180.

Each of the power storage systems 1 includes a vehicle 10, a gateway (GW) 20, and a charging and discharging facility 30. Each vehicle 10 includes a battery 12 that is a power storage device. The vehicle 10 is, for example, an electric automobile or a plug-in hybrid vehicle. The battery 12 is a battery that supplies electric power for traveling of the vehicle 10. The vehicle 10 may be a vehicle owned by an individual, a vehicle used by a business operator for business, a share car, or the like.

The control device 100 is connected to the aggregator server 180 via a communication network 190. The control device 100 can communicate with the charging and discharging facility 30 via the communication network 190. The control device 100 controls the charging and discharging facility 30 via the communication network 190. The control device 100 communicates with the vehicle 10 via the communication network 190 to acquire various types of information of the vehicle 10 including a travel history of the vehicle 10, a state of charge (SOC) and a state of health (SOH) of the battery 12.

The gateway 20 is installed in a dwelling unit 42 and can communicate with a power grid 90 and the charging and discharging facility 30.

The charging and discharging facility 30 and the power generation device 80 are connected to the power grid 90. The power generation device 80 includes, for example, a power plant operated by a power company. Electric power generated by the power generation device 80 may be supplied to the charging and discharging facility 30 through the power grid 90. The power grid 90 is, for example, a power system.

The charging and discharging facility 30 charges and discharges the battery 12 mounted on the vehicle 10 connected to the charging and discharging facility 30. When the charging and discharging facility 30 is installed in the dwelling unit 42 and discharges the battery 12, electric power provided from the battery 12 may be consumed by a power load in the dwelling unit 42 or may be provided to the power grid 90 through a power line installed in the dwelling unit 42. Further, the charging and discharging facility 30 may charge the battery 12 with electric power received from the power grid 90.

When electric power is transmitted and received between the power grid 90 and the battery 12, the vehicle 10 and the charging and discharging facility 30 charge and discharge the battery 12 according to control of the control device 100. For example, when power shortage occurs in the power grid 90, the control device 100 may transmit electric power from the battery 12 to the power grid 90 by instructing the vehicle 10 and the charging and discharging facility 30 to discharge the battery 12 via the gateway 20. When a power surplus occurs in the power grid 90, the control device 100 can reduce the power surplus of the power grid 90 by instructing the vehicle 10 and the charging and discharging facility 30 to charge the battery 12 via the gateway 20. In this way, the control device 100 may integrate the plurality of batteries 12 mounted on the plurality of vehicles 10 to provide a power resource for the power grid 90.

The aggregator server 180 is, for example, a server used by a power aggregator. The aggregator server 180 performs power transactions in a power market or the like. The control device 100 communicates with the aggregator server 180 to provide a necessary amount of power from the battery 12 to the power grid 90, or to receive a necessary amount of power for (that is, charge) the battery 12 from the power grid 90. For example, in response to a request from the aggregator server 180, the control device 100 controls the vehicle 10 and the charging and discharging facility 30 to discharge the battery 12, and provides electric power of an amount corresponding to the request to the power grid 90. Further, in response to a request from the aggregator server 180, the control device 100 may control the vehicle 10 and the charging and discharging facility 30 to charge the battery 12, and receive electric power of an amount corresponding to the request from the power grid 90. As described above, the vehicle 10 on which the battery 12 is mounted may appropriately control an amount of electric power by charging and discharging the battery 12.

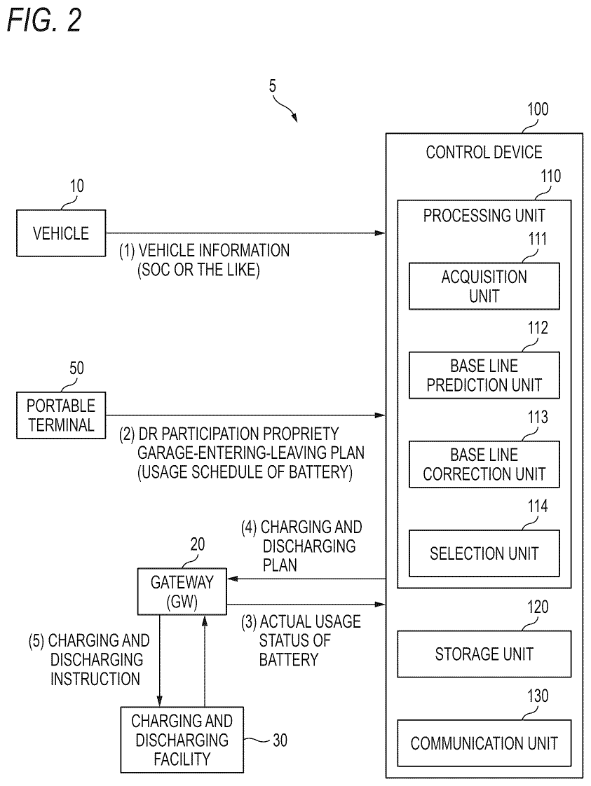

FIG. 2 is a block diagram of the control device 100 and a diagram showing a relationship between the control device 100 and other devices. The control device 100 is a device that controls, based on a request for a demand response (DR) for adjusting a power supply and demand balance in the power grid 90, charging and discharging of the plurality of batteries 12 owned by the plurality of consumers 40 who have declared participation in the DR with respect to the power grid 90.

The relationship between the control device 100 and other devices will be described. (1) The vehicle 10 transmits vehicle information including the travel history, the SOC of the battery 12, and the like to the control device 100. (2) The consumer 40 operates a predetermined application in a portable terminal 50 to input DR participation willingness related to whether to participate in the DR, a garage-entering-leaving plan related to a schedule for the vehicle 10 to enter and leave a garage, and the like. The garage-entering-leaving plan corresponds to a usage schedule of the battery 12. The portable terminal 50 transmits the received DR participation willingness, the garage-entering-leaving plan, and the like to the control device 100.

(3) The charging and discharging facility 30 transmits an actual usage status of the battery 12 to the gateway 20, and the gateway 20 transmits the actual usage status of the battery 12 to the control device 100. (4) The control device 100 transmits a created charging and discharging plan to the gateway 20. (5) The gateway 20 issues a charging and discharging instruction to the charging and discharging facility 30. The creation of the charging and discharging plan by the control device 100 will be described later.

The control device 100 includes a processing unit 110, a storage unit 120, and a communication unit 130. The processing unit 110 is implemented by an arithmetic processing unit including a processor, and performs main processing of the control device 100. The processing unit 110 may be implemented by a microcomputer including a CPU, a ROM, a RAM, an I/O, a bus, and the like. The control device 100 may be implemented by a computer. The storage unit 120 includes, for example, a non-volatile storage medium, and stores various data, programs, and the like. The processing unit 110 reads a program stored in the storage unit 120 to perform predetermined processing, for example. The communication unit 130 realizes communication with an external device.

The processing unit 110 includes an acquisition unit 111, a base line prediction unit 112, a base line correction unit 113, and a selection unit 114. The acquisition unit 111 acquires the usage history including the garage-entering-leaving plan in (2), that is, the usage schedule of the battery 12 received from each of the consumers 40 and the actual usage status of the battery 12 of each of the consumers 40 in (3). The acquisition unit 111 also acquires a future usage schedule of the battery 12 received from each of the consumers 40.

The base line prediction unit 112 predicts, for each of the consumers 40, a base line which is demand power assumed in a case where there is no request for the DR. The base line prediction unit 112 predicts the base line based on, for example, the future usage schedule of the battery 12 received from each of the consumers 40.

The base line correction unit 113 corrects, based on information related to a deviation between the usage schedule of the battery 12 contained in the usage history acquired by the acquisition unit 111 and the actual usage status, the base line in the DR to be executed this time. The correction is correction of the base line predicted by the base line prediction unit 112. The information related to the deviation will be described later.

The selection unit 114 selects, based on the corrected base line corrected by the base line correction unit 113, the battery 12 for charging and discharging power with respect to the power grid 90 among the plurality of batteries 12. The processing unit 110 creates the charging and discharging plan based on the selection of the selection unit 114.

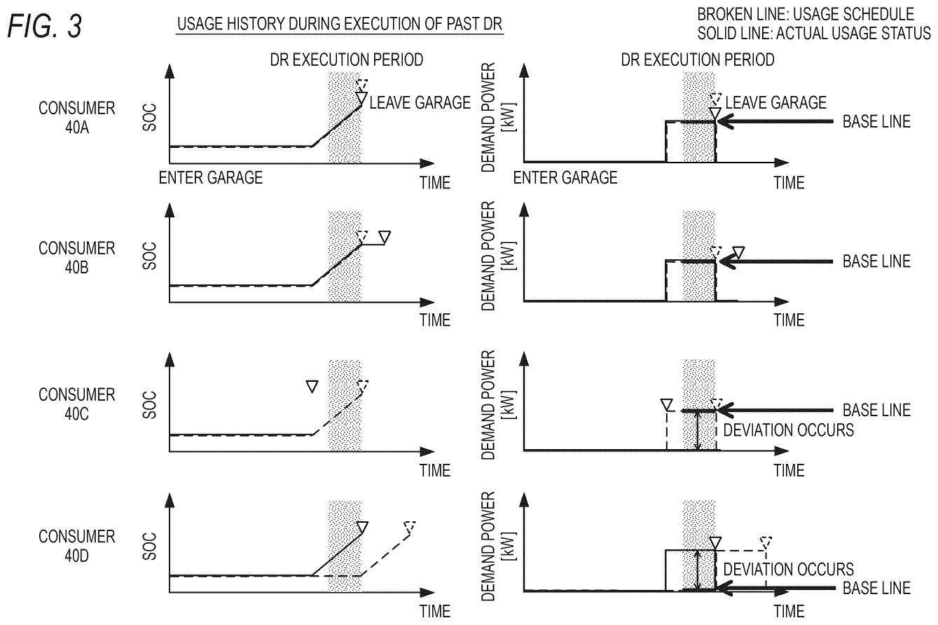

FIG. 3 shows graphs in relation to the usage history during execution of a past DR, including graphs (left side) of the SOC of the battery 12 used respectively by the plurality of consumers 40 (here, four consumers 40 are denoted as a consumer 40A, a consumer 40B, a consumer 40C, and a consumer 40D) and graphs (right side) of the demand power [KW]. Each of broken lines is a graph of the usage schedule of the battery 12, and each of solid lines is a graph of the actual usage status of the battery 12. Each of the base lines on the right side is predicted by the base line prediction unit 112 based on the usage schedule of the battery 12 received from the corresponding consumer using the portable terminal 50 in (2) of FIG. 2.

In a usage schedule (broken line) of the consumer 40A, the charging and discharging facility 30 starts charging of the battery 12 before a start of a DR execution period, and ends the charging at the same time as an end of the DR execution period, the vehicle 10 leaves the garage, and the demand power also increases during the charging period. In an actual usage status (solid line) of the consumer 40A, the charging and discharging facility 30 also starts the charging of the battery 12 before the start of the DR execution period, and ends the charging at the same time as the end of the DR execution period, and the vehicle 10 leaves the garage. Accordingly, it can be said that there is no deviation between the usage schedule and the actual usage status of the battery 12 at least during the DR execution period.

In a usage schedule (broken line) of the consumer 40B, the charging and discharging facility 30 starts the charging of the battery 12 before the start of the DR execution period, and ends the charging at the same time as the end of the DR execution period, the vehicle 10 leaves the garage, and the demand power also increases during the charging period. In an actual usage status (solid line) of the consumer 40B, the charging and discharging facility 30 starts the charging of the battery 12 before the start of the DR execution period, and ends the charging at the same time as the end of the DR execution period according to the usage schedule, but the vehicle 10 leaves the garage later than the usage schedule. However, it can be said that there is no deviation between the usage schedule and the actual usage status of the battery 12 at least during the DR execution period.

In a usage schedule (broken line) of the consumer 40C, the charging and discharging facility 30 starts the charging of the battery 12 before the start of the DR execution period, and ends the charging at the same time as the end of the DR execution period, the vehicle 10 leaves the garage, and the demand power also increases during the charging period. In an actual usage status (solid line) of the consumer 40C, the vehicle 10 leaves the garage ahead of schedule before the start of the DR execution period, and is not charged at least during the DR execution period. Therefore, demand power expected to be ensured in the charging period of the usage schedule cannot be ensured in the actual usage status. Accordingly, it can be said that there is a deviation between the usage schedule and the actual usage status of the battery 12 (here, the “demand power in the usage schedule”>the “demand power in the actual usage status”) at least during the DR execution period. For the consumer 40C, it can be said that a deviation occurs between the actual demand power contained in the usage history and the base line predicted based on the usage schedule, and the actual demand power is smaller than the predicted base line.

In a usage schedule (broken line) of the consumer 40D, the charging and discharging facility 30 starts the charging of the battery 12 at the same time as the end of the DR execution period, and ends the charging after a predetermined period of time has elapsed since the end of the DR execution period, the vehicle 10 leaves the garage, and the demand power also increases during the charging period. In an actual usage status (solid line) of the consumer 40D, the charging and discharging facility 30 starts the charging of the battery 12 before the start of the DR execution period, and ends the charging at the same time as the end of the DR execution period, and the vehicle 10 leaves the garage. Therefore, demand power not expected to be ensured in the charging period of the usage schedule may be ensured in the actual usage status. Accordingly, it can be said that there is a deviation between the usage schedule and the actual usage status of the battery 12 (here, the “demand power in the usage schedule”<the “demand power in the actual usage status”) at least during the DR execution period. For the consumer 40D, it can be said that a deviation occurs between the actual demand power contained in the usage history and the base line predicted based on the usage schedule, and the actual demand power is larger than the predicted base line.

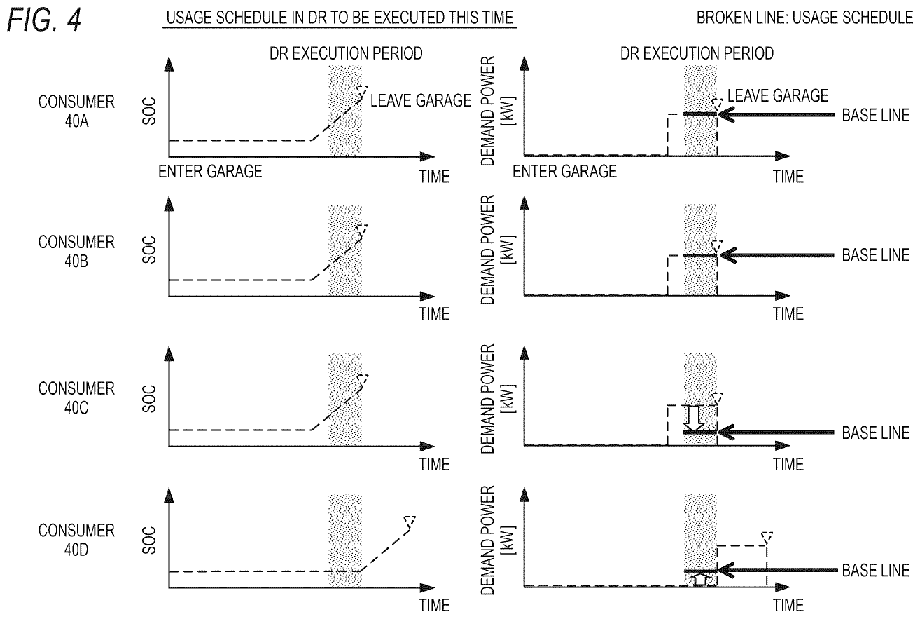

FIG. 4 shows graphs in relation to a usage schedule of the DR to be executed this time, including graphs (left side) of the SOC of the battery 12 used respectively by the consumer 40A, the consumer 40B, the consumer 40C, and the consumer 40D and graphs (right side) of the demand power [kW].

For the consumer 40A and the consumer 40B, in a past usage history, there is a tendency that there is no deviation between the usage schedule and the actual usage status of the battery 12 at least during the DR execution period, and thus the demand power predicted based on the usage schedule is predicted to actually occur. Accordingly, the base line prediction unit 112 predicts the demand power in the usage schedule of the battery 12 received from the consumer 40A and the consumer 40B as the base line, and the base line correction unit 113 does not correct the base line.

For the consumer 40C, as described with reference to FIG. 3, there is a tendency that the vehicle 10 leaves the garage ahead of schedule from the past usage history, and thus there is a possibility that the demand power cannot be ensured during a DR execution period of this time. Accordingly, the base line correction unit 113 performs correction to reduce the base line predicted by the base line prediction unit 112, specifically, the demand power in the usage schedule of the battery 12 received from the consumer 40C. As a specific example, in a case where there is a tendency for the consumer 40C that the vehicle 10 leaves the garage ahead of schedule once every three days, reliability of the usage schedule of the consumer 40C is not high, so that the base line correction unit 113 performs correction to reduce the base line by multiplying the base line by ⅓, which is an occurrence rate of the deviation.

For the consumer 40D, as described with reference to FIG. 3, there is a tendency that the vehicle 10 leaves the garage ahead of schedule from the past usage history, and thus there is a possibility that the demand power can be ensured during the DR execution period of this time, contrary to the usage schedule. Accordingly, since reliability of the usage schedule of the consumer 40D is not high, the base line correction unit 113 performs correction to increase the base line predicted by the base line prediction unit 112, specifically, the demand power in the usage schedule of the battery 12 received from the consumer 40C.

In order to predict the base line with high accuracy in response to the occurrence of the deviation, it is also conceivable not to select, as the battery 12 for charging and discharging during execution of the DR, the battery 12 of the consumer (specifically, the consumer 40C and the consumer 40D) having a large degree of deviation between the usage schedule and the actual usage status, but in this case, there may be a failure in ensuring the power resource that may be supplied during execution of the DR.

Meanwhile, according to the control device 100 of the present embodiment, since the base line correction unit 113 corrects, based on the information related to the deviation between the usage schedule and the actual usage status of the battery 12, the base line in the DR to be executed this time, the base line may be predicted with high accuracy even if the battery 12 of a consumer having a large degree of deviation is selected. Accordingly, the failure in ensuring the power resource that can be supplied during execution of the DR may be prevented. As a result, a supply resource of power during the DR execution period may be prevented from being insufficient.

Further, according to the control device 100 of the present embodiment, as described with reference to FIGS. 3 and 4 in relation to the consumer 40C, when a deviation occurs between the actual demand power contained in the usage history and the predicted base line and the actual demand power is smaller than the predicted base line, the base line correction unit 113 reduces, based on the occurrence rate of the deviation, the base line in the DR to be performed this time.

Accordingly, the base line correction unit 113 reduces the base line based on the occurrence rate of the deviation for the battery 12 of the consumer 40C that is highly likely to be unable to ensure sufficient demand power during the DR execution period, and thus the base line may be predicted with higher accuracy.

Further, according to the control device 100 of the present embodiment, the base line prediction unit 112 may predict, for each of the consumers 40, the base line in the DR to be performed this time, based on the usage schedule received from the consumer 40. Then, the base line correction unit 113 may correct the base line by weighting the base line in the DR to be performed this time with a reliability coefficient indicating reliability of the usage schedule. The reliability coefficient may be set, for example, based on the occurrence rate of the deviation between the actual demand power contained in the usage history and the predicted base line, and the reliability coefficients of the consumers 40A and 40B are set to be higher (for example, 1), and the reliability coefficients of the consumers 40C and 40D are set to be lower (for example, between 0 and 1).

When the base line is predicted based on the usage schedule of the battery 12, the degree of deviation between the usage schedule and the actual usage status may greatly vary depending on the consumer 40, and a prediction error of the base line may increase. According to the control device 100 of the present embodiment, since the base line correction unit 113 corrects the base line in consideration of the reliability coefficient indicating the reliability of the usage schedule received from the consumer 40, the base line may be predicted with high accuracy. The reliability coefficient may be obtained based on the above-described occurrence rate of the deviation or may be obtained by other methods.

Although the embodiment has been described above with reference to the drawings, it is needless to say that the present invention is not limited to these examples. It is apparent that those skilled in the art can conceive of various modifications and alterations within the scope described in the claims, and it is understood that such modifications and alterations naturally fall within the technical scope of the present invention. In addition, respective constituent elements in the above-described embodiment may be freely combined without departing from the gist of the invention.

In this specification, at least the following matters are described. Although corresponding constituent elements or the like in the embodiment described above are shown in parentheses, the present invention is not limited thereto.

(1) A control device for controlling, based on a request for a demand response (DR) for adjusting a power supply and demand balance in a power grid (power grid 90), charging and discharging of a plurality of power storage devices (battery 12), that are respectively owned by a plurality of consumers (consumers 40A to 40D) who have declared participation in the DR, with respect to the power grid, the control device including:
an acquisition unit (acquisition unit 111) configured to acquire a usage history including a usage schedule of the power storage device received from each of the consumers and an actual usage status of the power storage device of each of the consumers;
a base line prediction unit (base line prediction unit 112) configured to predict, for each of the consumers, a base line which is demand power assumed in a case where there is no request for the DR;
a base line correction unit (base line correction unit 113) configured to correct, based on information related to a deviation between the usage schedule and the actual usage status which are contained in the usage history, the base line in the DR to be executed this time; and
a selection unit (selection unit 114) configured to select, based on the corrected base line, the power storage device for charging and discharging power with respect to the power grid among the plurality of power storage devices.

In order to predict the base line with high accuracy, it is also conceivable not to select, as the power storage device for charging and discharging during execution of the DR, the power storage device of the consumer having a large degree of deviation between the usage schedule and the actual usage status, but in this case, there may be a failure in ensuring the power resource that can be supplied during execution of the DR. According to (1), since the base line in the DR to be executed this time is corrected based on the information related to the deviation between the usage schedule and the actual usage status of the power storage device, the base line may be predicted with high accuracy even if the power storage device of the consumer having a large degree of deviation is selected. Accordingly, the failure in ensuring the power resource that can be supplied during execution of the DR may be prevented. As a result, the supply resource of power during the DR execution period may be prevented from being insufficient.

(2) The control device according to (1), in which
when a deviation between an actual demand power contained in the usage history and the predicted base line occurs and the actual demand power is smaller than the predicted base line, the base line correction unit reduces, based on an occurrence rate of the deviation, the base line in the DR to be executed this time.

According to (2), the base line is reduced based on the occurrence rate of the deviation for the power storage device of the consumer that is highly likely to be unable to ensure sufficient demand power during the DR execution period, and thus the base line may be predicted with higher accuracy.

(3) The control device according to (1) or (2), in which
the base line prediction unit predicts the base line in the DR to be executed this time for each of the consumers based on the usage schedule received from the corresponding consumer, and
the base line correction unit corrects the base line by weighting the base line in the DR to be executed this time with a reliability coefficient indicating reliability of the usage schedule.

When the base line is predicted based on the usage schedule of the power storage device, the degree of deviation between the usage schedule and the actual usage status may greatly vary depending on the consumer, and an prediction error of the base line may increase. According to (3), since the base line is corrected in consideration of the reliability coefficient indicating the reliability of the usage schedule received from the consumer, the base line may be predicted with high accuracy.

What is claimed is:

1. A control device for controlling, based on a request for a demand response (DR) for adjusting a power supply and demand balance in a power grid, charging and discharging of a plurality of power storage devices, that are respectively owned by a plurality of consumers who have declared participation in the DR, with respect to the power grid, the control device comprising:
an acquisition unit configured to acquire a usage history including a usage schedule of the power storage device received from each of the consumers and an actual usage status of the power storage device of each of the consumers;
a base line prediction unit configured to predict, for each of the consumers, a base line which is demand power assumed in a case where there is no request for the DR;
a base line correction unit configured to correct, based on information related to a deviation between the usage schedule and the actual usage status which are contained in the usage history, the base line in the DR to be executed this time; and
a selection unit configured to select, based on the corrected base line, the power storage device for charging and discharging power with respect to the power grid among the plurality of power storage devices.

2. The control device according to claim 1, wherein
when a deviation between an actual demand power contained in the usage history and the predicted base line occurs and the actual demand power is smaller than the predicted base line, the base line correction unit reduces, based on an occurrence rate of the deviation, the base line in the DR to be executed this time.

3. The control device according to claim 1, wherein
the base line prediction unit predicts the base line in the DR to be executed this time for each of the consumers based on the usage schedule received from the corresponding consumer, and
the base line correction unit corrects the base line by weighting the base line in the DR to be executed this time with a reliability coefficient indicating reliability of the usage schedule.
